(19) United States
(12) Patent Application Publication
(10) Pub. No.: US 2002/0031567 A1
(43) Pub. Date: Mar. 14, 2002

(54) Internet-based remote control system for molding machine

(75) Inventor: Takashi Magario, Nagano-ken (JP)

Correspondence Address: MERCHANT & GOULD PC, P.O. BOX 2903, MINNEAPOLIS, MN, 55402-0903, US

(73) Assignee: Nissei Plastic Industrial Co., Ltd.

(21) Appl. No.: 09/952,238

(22) Filed: Sep. 10, 2001

(30) Foreign Application Priority Data
Sep. 12, 2000 (JP) 2000-276872

(51) Int. Cl. B29C 47/92

(52) U.S. Cl. 425/135

(57) ABSTRACT

A control system for a molding machine includes a control unit having a communication function to connect the control unit with a portable data terminal such as a mobile phone through the Internet so that operation of the molding machine can be controlled based on instructions given from remote locations via the mobile phone.

### BACKGROUND OF THE INVENTION

The present invention relates generally to a system for monitoring and controlling a molding machine, and more particularly to an Internet-based remote control system that can perform the monitoring and control of a molding machine from remote locations or during transportation by using a portable data terminal such as a mobile phone connected to a control unit via the Internet.

Japanese Patent No. 2917181 shows a conventional communication system for performing the maintenance of an injection molding machine from remote locations. The conventional communication system includes a microcomputer incorporated in a body of the injection molding machine. The microcomputer has an automatic operation control function, a diagnostic function and an automatic calling function. By virtue of the automatic calling function, when a trouble higher in severity than a predetermined level occurs in the injection molding machine, the microcomputer sends a message by way of a voice message when addressed to a telephone receiver or image data when directed to a facsimile machine. This arrangement ensures that when a trouble occurs in the injection molding machine during unmanned automatic operation, the microcomputer notifies a supervisory person of the occurrence of the trouble by means of a telephone receiver or a facsimile machine through public telephone lines.

In recent years, with the progress of information technology (IT), the Internet has been widely spread, and mobile phones (portable telephones) or portable data terminals have become very practical as a terminal accessible to the Internet. It is, therefore, desirable that the communication system is used to achieve a high-level control of a molding machine, including collection, storage, control and alteration of data relative to operating conditions of the molding machine and its peripheral equipment, product qualities, production planning, etc., additional to notification of a trouble to a supervisory person existing at a distant place.

### SUMMARY OF THE INVENTION

It is accordingly an object of the present invention to provide an Internet-based remote control system which is able to perform a high-level control of operation of a molding machine using a mobile phone and the Internet.

To achieve the foregoing object, according to the present invention, there is provided a control system for a molding machine, comprising: at least one molding machine; peripheral equipment which assist operation of the molding machine; detecting devices for detecting operating conditions of the molding machine and the peripheral equipment; a control unit for controlling operations of the molding machine and the peripheral equipment to produce a molded article based on information supplied from the detecting devices; and a portable data terminal that can be hand-carried about remote locations. The control unit has a communication function to connect the control unit with the Internet and perform communication with the portable data terminal via the Internet. The control unit performs transfer of various items of information between itself and the portable data terminal so as to achieve the monitoring and control of the molding machine based on instructions from the portable data terminal. In one preferred form of the present invention, the control unit comprises a process controller mounted on the molding machine, and a host computer connected to the process controller by a communication line.

By using the portable data terminal, such as a mobile phone, and the Internet in combination, it becomes possible to control operation of the molding machine from remote locations while monitoring various items of information on a real time basis. The operating conditions of the molding machine and peripheral equipment, collected from the detecting devices in the control unit, can be reproduced on a display of the portable data terminal and used for the maintenance of the molding machine and peripheral equipment. The portable data terminal may us used to alter the molding conditions and the manufacturing plan stored in advance in the control unit.

The information items may include information about the molding machine, information about the peripheral equipment, information about operations of the molding machine and the peripheral equipment, information about molding conditions, information about the manufacture and information about the molded article. The information about the manufacture may comprise information about the manufacturing plan. The information items thus selected ensures a high-level remote control of the molding machine including collection, storage, supervising and alteration of data required not only for the maintenance of the molding machine but also for the control of product qualities and manufacturing plan. The alteration of information about the manufacturing plan is particularly advantageous when multiple molding machines installed on the same production site are controlled by a computer disposed in the production site. The respective manufacturing plans set for the molding machines in advance can be altered separately from remote locations by means of the portable data terminal which is connected to the computer via the Internet.

It is preferable that the portable data terminal comprises a mobile phone. The mobile phone is preferably of the type adapted for World Wide Web or designed for connection with the Internet. The mobile phone may be used to give instructions to alter the molding conditions or the manufacturing plan.

The above and other objects, features and advantages of the present invention will become manifest to those versed in the art upon making reference to the following description and accompanying sheets of drawings in which a certain preferred structural embodiment incorporating the principle of the invention is shown by way of illustrative example.

### BRIEF DESCRIPTION OF THE DRAWINGS

FIG. 1 is a diagrammatical view showing the general arrangement of a molding machine control system according to an embodiment of the present invention;

FIG. 2 is a block diagram the molding machine control system, showing structural details of a control unit; and

FIG. 3 is a diagrammatical view showing another form of application of the molding machine control system according to the present invention.

### DETAILED DESCRIPTION OF THE PREFERRED EMBODIMENTS

The following description is merely exemplary in nature and is in no way intended to limit the invention or its application or use.

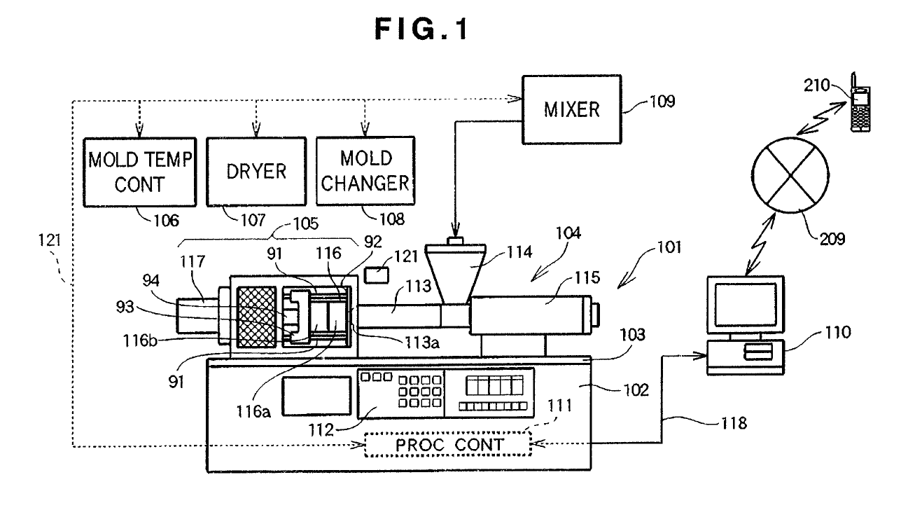

Referring to the drawings and FIG. 1 in particular, there is shown a molding machine control system according to an embodiment of the present invention. The control system generally comprises an injection molding machine 101, various units of peripheral equipment 106-109 and a control unit 110, 111.

The injection molding machine 101 includes a support table or frame 102, a bed 103 mounted on the support frame 102, an injection device 104 and a clamp device 105, these devices 104, 105 being mounted on the bed 103 in tandem relation. A digital camera (a digital video camera or a video camera) 121 is disposed in the proximity of the clamp device 105 for taking up images of a molded article.

The peripheral equipment 106-109 is provided to assist operation of the injection molding machine 101. In the illustrated embodiment, the peripheral equipment is composed of a mold temperature controller 106, a dryer 107, a mold changer 108 and a mixer 109. A host computer 110 is associated with the injection molding machine 101 for a purpose described below.

The control unit 111 is composed of a process controller such as a microcomputer and is disposed interiorly of the support frame 102. An operation control panel 112 having multiple operation control keys is mounted to a front side of the support frame 102. The operation control keys are manipulated by the operator so that the necessary data for a molding process can be supplied to the process controller 111.

The injection device 104 is composed of a heating cylinder 113 for heating a plastic molding material, a hopper 114 for storing the plastic material to be supplied to the heating cylinder 113, and an injection cylinder 115. The injection cylinder 113 generally has a screw disposed therein. The plastic molding material supplied from the hopper 114 into the heating cylinder 113 is heated by a heater (not shown) arranged around the periphery of the heating cylinder 113 and, as it is transferred toward a discharge nozzle 113a by rotation of screw, the plastic molding material is plasticized and kneaded. During that time, the screw is moved backward by a counter force a melt accumulated around the tip end of the screw. The amount of melt can be metered by measuring the retreating or backward stroke of the screw. Then, the screw is rapidly advanced at one stroke to cause a metered amount of melt accumulated forward of the screw to be injected through the nozzle 113a into a mold 116. The injection cylinder 115 is driven by a suitable drive source such as a hydraulic drive unit or an electric drive unit.

The clamp device 105 keeps the mold 116 in a fully closed position while the molten plastic molding material is injected from the nozzle 113a of the heating cylinder 113 into the mold 116. After the lapse of an appropriate cooling time set for solidification of the injected molten material, the clamp device 105 opens the mold 116 to allow a molded article to be removed from the mold 116. The clamp device 105 includes four horizontal tie bars 91, a fixed clamp plate 92 connected to one end of the tie bars 91, and a movable clamp plate 93 slidably mounted on the tie bars 91. The movable clamp plate 93 is connected to the piston rod 94 of a clamp cylinder 117. A fixed mold member 116a of the mold 116 is attached to the fixed clamp plate 91, and a movable mold member 116b of the mold 116 is attached to the movable clamp plate 93. With this arrangement, when the clamp cylinder 117 is activated, the movable mold member 116b moves toward the fixed mold member 116a to close a mold cavity (not shown) defined between mated mold surfaces of the movable and fixed mold members 116b, 116a. The molten plastic material is injected from the nozzle 113a via the fixed clamp plate 92 into the mold cavity of the mold 116. During the injection process, a large clamp force is applied from the clamp cylinder 117 to the mold 116 so that the mold 116 is kept in its fully closed position.

Respective operations of the injection device 104 and the clamp device 105 are repeated in a given sequence until a predetermined number of molded articles are produced. The sequence of operations of the clamp device 105 is determined by sequential control achieved in the process controller 111.

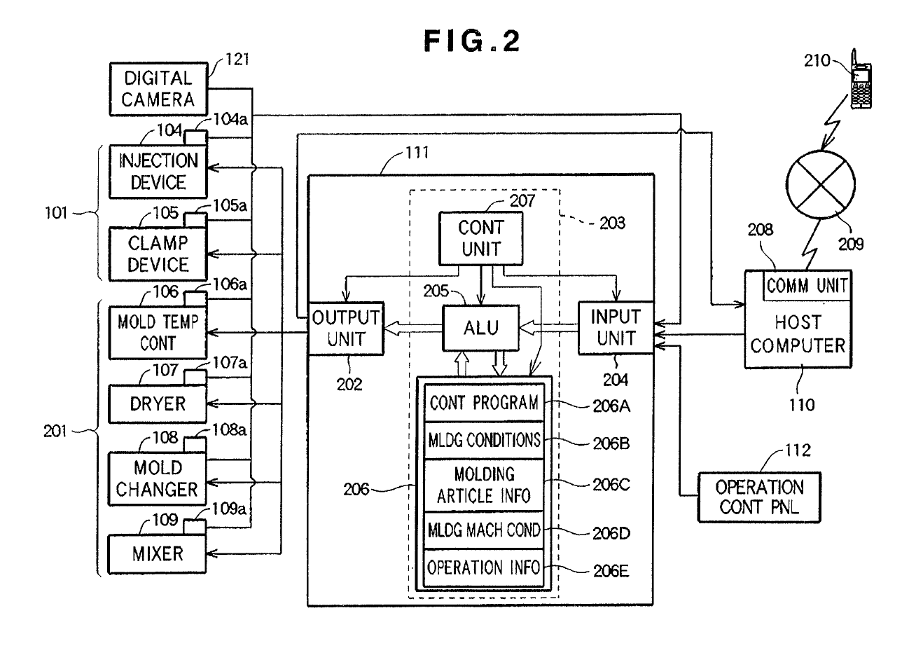

The injection molding process is achieved mainly based on operations of the injection device 104 and clamp device 105. During that time, various units of peripheral equipment including the mold temperature controller 106, dryer 107, mold changer 108 and mixer 109 are driven to operate in timed relation to the operation of the injection molding machine 101 so as to assist operation of the injection molding machine 101. The mold temperature controller 106 controls the temperature of the mold 116. The dryer 107 drys to dry the molded articles. The mold changer 108 changes the mold depending on an article to be molded. The mixer 109 mixes up two or more molding materials homogeneously and feeds a mixture to the hopper 114 Though not shown in FIG. 1, the peripheral equipment may further include a molded-article removing robot, a molding material feeder, a conveyor, a runner crusher, and a cooling device. Respective operations of these units 106-109 of peripheral equipment are controlled by the process controller 111 as indicated by the broken lines 121 shown in FIG. 1. Operating conditions of the respective peripheral units 107-109 are detected by associated detecting devices 106a-109a (FIG. 2), and detected items of information about the detected operating conditions are sent from the detecting device 106a-109a to the process controller 111.

The host computer 110 is connected by a communication cable 118 to the process controller 111 of the injection molding machine 101. The host computer 110 may be disposed either close to or remotely from the injection molding machine 101. In the latter case, both the host computer 110 and the process controller 111 are equipped with a communication control part or unit and a communication part or unit so as to perform transfer of data through a communication line composed of the communication cable 118.

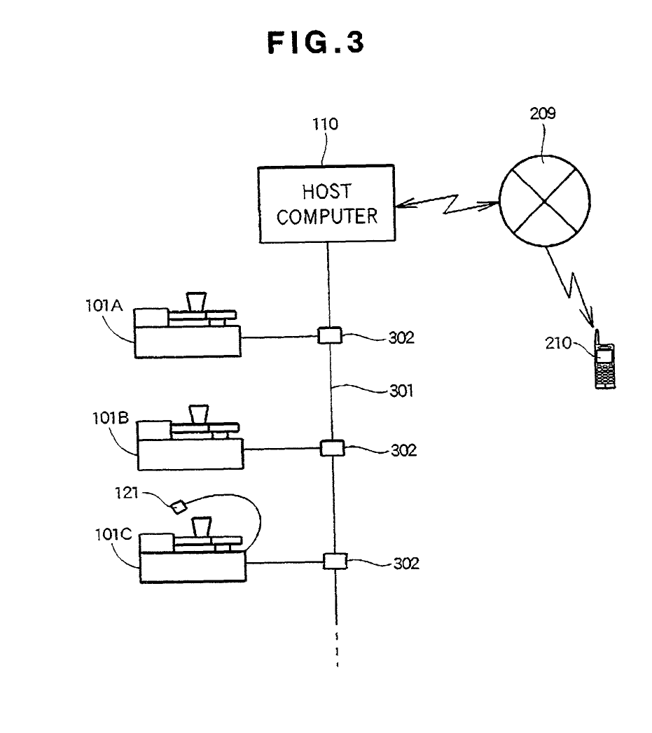

The host computer 110 has a function to set and control operating conditions of the injection molding machine 101 and peripheral equipment 106-109 via the process controller 111. In FIG. 1 only one injection molding machine 101 is illustrated, two or more injection molding machines of similar construction may be used as will be described with reference to FIG. 3.

FIG. 2 shows structural details of the molding machine control system of the present invention. As previously described, the process controller 111 controls operations of the injection device 104 and clamp device 105 of the injection molding machine 101 as well as operations of the mold temperature controller 106, dryer 107, mold changer 108 and mixer 109 of the peripheral equipment 201. Though not shown, various valve mechanisms incorporated in the non-illustrated hydraulic drive unit and various electric driving units, that are provided to drive the injection device 104 and clamp device 105, are also controlled in operation by the process controller 111. The process controller 111 has an output unit 202 which outputs command signals to the injection device 104, clamp device 105, mold temperature controller 106, dryer 107, mold changer 108 and mixer 109 for controlling operations of these devices. Detecting devices 104a, 105a, 106a, 107a, 108a and 109a are each associated with a corresponding one of the injection device 104, clamp device 105, mold temperature controller 106, dryer 107, mold changer 108 and mixer 109 for detecting operating conditions of the associated device 104-109. In the illustrated embodiment, only one detecting device is associated with the corresponding device. In a practical application, however, the detecting device is composed of a group of sensors arranged to detect or take up various necessary items of information with respect to each device 104-109. Detection signals output from the detecting devices 104a-109a are input to an input unit 204 of the process controller 111.

The process controller 111 is composed of the input unit 204, the output unit 202, and a central processing unit (CPU) 203. The CPU 203 includes an arithmetic and logic unit (ALU) 205, an internal storage or memory 206 and a control unit 207. The ALU retrieves from the storage 206 a control program and pieces of data relative to various items of information such as molding conditions and controls, on the basis of the retrieved data pieces, operations of the injection molding machine 101 and peripheral equipment 201 according to the control program. The memory 206 stores therein, at least, control programs 206A, data 206B about molding conditions, data 206C about molded articles (molded article information), data 206D about states or conditions of molding machine, and data 206E about operations of the injection molding machine 101 and peripheral equipment 201. The control programs 206A include a program for controlling operation of injection molding machine 101, a program for controlling operations of various units 106-109 of peripheral equipment 201, and a program for performing a given product planning. The data about molding conditions 206D includes the input/output state of injection molding machine 101, command values supplied to the pumps and motors, motor load torque, voltage of each detecting device and other maintenance information, the occurrence of errors, and the number of molded articles. The molded article information 206C includes quantitative data and image data about molded articles collected per each shot of molding. The image data of molded articles is taken up by the digital camera 121 disposed in the proximity of the clamp device 105 of the injection molding machine 101. The operation information data 206E includes data about operating conditions of the injection molding machine 101 and data about operating condition of the peripheral equipment 201 as described previously.

The process controller 111 may further has a communication control part or function formed by a communication control program stored in the memory 206 in advance so as to perform communication (i.e., transfer of data) between the process controller 111 and the host computer 110. This arrangement is particularly suitable for an application in which the host computer 110 is located far distant from the injection molding machine 101.

Reading and writing of the programs and data pieces previously described can be achieved freely. They may be changed or altered when necessary. In addition, the writing, reading and altering of the programs and data pieces can be done according to instructions given from remote locations. Thus, the control programs and data pieces can be altered either directly at the production site where the injection molding machine 101 is installed, or alternately by remote control effected at a distant place. The control unit 207 controls operations of the output unit 202, input unit 204, ALU 205 and memory 206 and thus supervises the overall operation of the process controller 111.

The process controller 111 mainly performs sequence control of the injection molding machine 101 for repeated production of a molded article through a given sequence of operations, process control of operating conditions of the injection molding machine 101, peripheral equipment 201 and other parts or components, and control for indirect judgment of the quality of molded articles.

The process controller 111 of the foregoing construction is connected to the operation control panel 112 and the host computer 110 as previously described. The operation control panel 112 is mounted to the front side of the support frame 102 (FIG. 1) of the injection molding machine 101. The host computer 110 is a supervising machine used for providing the process controller 111 of the injection molding machine 101 with a control program for setting a manufacturing plan and a sequence of operations to be achieved, and data for setting and altering the molding conditions. The information concerning respective operating states or conditions of the injection molding machine 101 and peripheral equipment 201, that is collected by the detecting devices 104a-109a and stored in the memory 206 of the process controller 111, is also supplied to the host computer 110.

The host computer 110 has a data communication part or unit 208. The host computer 110 can, therefore, be connected via the communication unit 208 to the Internet (or a portable data terminal network) 209 so as to perform data communication with external terminals involved in the Internet. In FIG. 2, a mobile phone (portable telephone) 201 is shown as a suitable example of such external terminals of the Internet 209. Other forms of external terminals may be possible, however, portable data terminals and personal digital assistants (PDA) are preferable because they are easy to operate and handy to carry.

According to the arrangement shown in FIGS. 1 and 2, the injection molding machine 101 can automatically operate to continuously produce an injection-molded article under the control of the process controller 111. In this instance, since the process controller 111 and the host computer 110 are connected together by the communication cable (or a dedicated line), the control programs and various pieces of data stored in the memory 206 of the process controller 111 are supervised and altered by the host computer 110. The supervising host computer 110 equipped with the communication unit 208 (FIG. 2) can be connected via the Internet 209 to the mobile phone 210 carried by a supervisory person at a remote place. This arrangement allows the supervisory person to access the host computer 110 through the Internet 209 using the mobile phone 210.

The supervising host computer 110 has a domain name system (DNS) function, so that through the Internet 209, the host computer 110 can perform the delivery and receiving of control programs and various pieces of data collected as information about the injection molding machine. The host computer 110 having such DNS function forms a DNS server. Thus, by way of an electronic-mail (E-mail) function or a browser function of the mobile phone 210, the supervisory person even standing at distant place can get information form, or give instructions to, the DNS server 110 through the Internet 209.

When an access from the mobile phone 210 to the DNS server address of the host computer 110 is made through the Internet 209, a menu is shown on a display of the mobile phone 210. The contents of the menu may include molding machine information, manufacturing information, molding conditions control information, quality control information, product information, and peripheral equipment information. These items of information are supplied from the process controller 111 to the host computer 110. Thus the necessary information can be obtained at a remote place through the Internet 209. Another arrangement may be possible according to the invention, in which dialing-up connection is used to connect the process controller 111 and the host computer 110 with a head office's server through another network-service provider.

The foregoing items of information contained in the menu are as follows. The molding machine information includes conditions of the molding machine 101 data used for maintenance of the molding machine 101, etc. The manufacturing information includes the type of molded article being produced, a total number of articles to be produced, the number of molded articles already produced, the number of errors, operating time, expected finishing time, etc. The molding condition control information includes current molding conditions and so on. The quality control information includes information about articles being molded and monitorial data that can be compared in real time. The product information includes information about article being molded and an image of the molded article per each shot of molding. The peripheral equipment information includes information about conditions and setting of the peripheral equipment 201.

The contents of the menu displayed based on the DNS server function of the host computer 110 can be processed in various manners by using the mobile phone 210. For instance, the number of molded articles to be produced can be changed. When an instruction to change the number of article to be produced is given to the host computer 110 through the DNS function, the host computer 110 accesses the memory 206 of the process controller 111 through the communication cable 118 and modifies the data such that the number of molded articles to be produced previously stored in the memory 206 is in equal to the number as instructed. With respect to the molding conditions control information, two or more molding conditions can be changed or altered. Upon receipt of an instruction to alter molding conditions via the DNS function, the host computer 110 accesses the memory 206 of the process controller 111 and alters data about the corresponding molding conditions as instructed. The thus altered data is displaced on a menu page of the post computer 110 on a real time basis. The molded article produced in accordance with the specified conditions is image taken up by the digital camera 121 in the form of image data. The image data of the molded article can be reproduced by down-loading on a display screen of the mobile phone 210. The product information can be also read out by downloading from the memory 206 onto the display screen of the mobile phone 210.

The E-mail function of the host computer 110 is used to provide a warning message to the mobile phone 210. When a trouble occurs in the injection molding machine 101 or the peripheral equipment 201, an appropriate message or sign indicative of the trouble occurred is sent to the mobile phone 210 as a warning notice to the supervisory person. Stated more specifically, when the process controller 111 detects the occurrence of a trouble in the injection molding machine 101 or in the peripheral equipment 201 based on the outputs from the detecting devices 104a-109a (FIG. 2), an appropriate message is sent from the process controller 111 to the host computer 110 which in turn sends a corresponding message to the mobile phone 210 via the E-mail. In this instance, by properly allocating different types of troubles to separate addresses in advance, it is readily possible to determine the type of the current trouble. In general, the mobile phone 210 can be set to emit a specific tone when it receives a message. By checking the message received, the supervisory person can determine the type of the current trouble and, when necessary, he or she can take an appropriate measure to recover the trouble through the Internet 209 and the host computer 110 by sending instructions from the mobile phone 210 at a distant place.

FIG. 3 shows another form of application of the molding machine control system according to the present invention. In this application, multiple injection molding machines (three being shown) 101A, 101B, 101C are employed Respective process controllers (not shown but identical to one 111 shown in FIGS. 1 and 2) of the injection molding machines 101a-101C are connected to a single host computer 110 by a LAN communication cable 301 and connectors or couplers 302. The structural details of the injection molding machines 101A-101C and the host computer 110 are the same as those described above with respect to the embodiment shown in FIGS. 1 and 2. The host computer 110 is adapted to communicate with a mobile phone (portable telephone) 210 via the Internet 209. The host computer 110 can perform transfer of information, data, instructions and so on between itself and the respective process controllers of the injection molding machines 101A-101C and also between itself and the mobile phone 210, in the same manner as described above. The control system of the foregoing construction is able to perform the monitoring and control of plural injection molding machines 101A-101C.

In the embodiments described above, the host computer has a DNS function. The DNS function may be provided for each injection molding machine so that transfer of information through the Internet can be achieved on an individual molding machine basis.

The type of molding machine applicable to the present invention should by no means be limited to the injection molding machine as in the illustrated embodiments. Although in the illustrated embodiment, the portable data terminal is used as a meas for collecting data from remote locations, any other terminal devices can be used provided that they can be connected to the Internet.

As described above, the molding machine control system of the present invention includes a control unit composed of a process controller and/or a host computer having a communication function to connect the control unit with a portable data terminal via the Internet. With this arrangement, by using the portable data terminal such as a mobile phone and the Internet in combination, it is possible to control the operation of the molding machine from remote locations while using information collected from detecting devices with respect to conditions of the molding machine. This system facilitates easy maintenance of the molding machine and ensures a high-level remote control of the molding machine including an alteration of the molding conditions and a modification of the manufacturing plan without requiring attendance of the operator at the production site.

Obviously, various minor changes and modifications of the present invention are possible in the light of the above teaching. It is therefore to be understood that within the scope of the appended claims, the present invention may be practiced otherwise than as specifically described.

What is claimed is:

1. A control system for a molding machine, comprising:
at least one molding machine;
peripheral equipment which assist operation of the molding machine;
detecting devices for detecting operating conditions of the molding machine and the peripheral equipment;
a control unit for controlling operations of the molding machine and the peripheral equipment to produce a molded article based on information supplied from the detecting devices; and
a portable data terminal that can be hand-carried about remote locations,
wherein the control unit has a communication function to connect the control unit with the Internet and perform communication with the portable data terminal via the Internet, and
wherein the control unit performs transfer of various items of information between itself and the portable data terminal so as to achieve the monitoring and control of the molding machine based on instructions from the portable data terminal.

2. A control system for a molding machine according to claim 1, wherein the information items include information about the molding machine, information about the peripheral equipment, information about operations of the molding machine and the peripheral equipment, information about molding conditions, information about the manufacture and information about the molded article.

3. A control system for a molding machine according to claim 2, wherein the information about the manufacture comprises information about the manufacturing plan.

4. A control system for a molding machine according to one of claim 1, wherein the portable data terminal comprises a mobile phone.

5. A control system for a molding machine according to claim 4, wherein the mobile phone is used to give instructions to alter the molding conditions or the manufacturing plan.

6. A control system for a molding machine according to claim 1, wherein the control unit comprises a process controller mounted on the molding machine, and a host computer connected to the process controller by a communication line.
